(19) United States
(12) Patent Application Publication
(10) Pub. No.: US 2012/0311091 A1
(43) Pub. Date: Dec. 6, 2012

(54) DIGITAL RIGHTS PROTECTION THROUGH CONTENT EXPIRATION ENFORCEMENT

(75) Inventors: John R. DINGLER, Dallas, GA (US); Blaine H. DOLPH, Western Springs, IL (US); Frank C. FISK, Lawrenceville, GA (US); Matthew A. TERRY, Dunwoody, GA (US); Matthew B. TREVATHAN, Kennesaw, GA (US)

(73) Assignee: INTERNATIONAL BUSINESS MACHINES CORPORATION, Armonk, NY (US)

(21) Appl. No.: 13/149,185

(22) Filed: May 31, 2011

(51) Int. Cl. G06F 15/16

(52) U.S. Cl. 709/219

(57) ABSTRACT

A method for controlling content distribution is implemented in a computer infrastructure and includes receiving a request for content from an end user computing device. The method also includes analyzing metadata embedded in the content to determine whether the content has expired. The method also includes serving the content to the end user computing device when content is not expired. The method also includes blocking the content from being served to the end user computing device when the content is expired

### TECHNICAL FIELD

The present invention generally relates to content distribution, and more particularly, to methods and systems for controlling exposure of expired content.

### BACKGROUND

Of the various marketing techniques, public endorsement by a highly recognized person such as a famous athlete, celebrity, or musician is one of the most powerful tools an organization can utilize to build their brand and/or break into a niche demographic. In addition to famous persons, companies may also seek out the endorsement of organizations that can add credibility to their product claims.

One drawback to using a famous person's likeness, an organization's name, etc., in advertising is that it requires explicit permission typically involving a written license or endorsement agreement. The permission typically expires after a period of time. In many cases, this permission comes at substantial cost along with financial penalties if it is used beyond the expiration period.

This introduces the problem of tightly controlled content expiration, particularly on Internet websites. It is a business critical task to ensure that licensed content is not displayed once it has reached its expiration. In most cases, enterprise content management systems provide various mechanisms to specify the lifespan of a web page, which contains the marketing textual content including any licensed images that augment such content. Content expiration is commonly done at the web page level and not the image level. In many cases, this is sufficient since the user cannot see the image without the web page displaying and referencing the image in the first place. Additionally, content management systems may go a step further and allow a content author to specify the expiration of an image itself. This causes the content delivery system to stop deploying the image to application or web servers at the specified time. This also reduces the probability that a company will violate a contractual obligation by displaying an expired image and suffer financial impacts.

However, such solutions where web page and image expiration are enforced by a content management system have proven insufficient when dealing with extremely costly image licenses. In real world scenarios, expired images have found their way to accessible Internet servers and resulted in financial consequences for companies that no longer had the rights to the image.

### SUMMARY

In a first aspect of the invention, a method implemented in a computer infrastructure includes receiving a request for content from an end user computing device. The method also includes analyzing metadata embedded in the content to determine whether the content has expired. The method also includes serving the content to the end user computing device when content is not expired. The method also includes blocking the content from being served to the end user computing device when the content is expired.

In another aspect of the invention, there is a system implemented in hardware and comprising a processor executing a content manager that operates to retrieve, from cache, content requested by an end user computing device. The content manager also operates to determine the content is one of expired and not expired, wherein the determining comprises analyzing metadata embedded in the content. The content manager also operates to serve the content to the end user computing device when the determining comprises determining the content is not expired. The content manager also operates to block the content from being served to the end user computing device when the determining comprises determining the content is expired.

In an additional aspect of the invention, there is a computer program product comprising a computer usable storage medium having readable program code embodied in the storage medium. The computer program product includes at least one component operable to: receive a request for an image file from an end user computing device; retrieve the image file from a cache; determine the image file is expired by comparing an expiration date embedded as metadata in the image file to a current date; and serve to the end user computing device one of: an updated image file having a later expiration date and a replacement image file generated according to a remediation configuration file.

In a further aspect of the invention, there is a computer system for controlling content distribution. The system comprises a CPU, a computer readable memory and a computer readable storage media. Additionally, the system comprises first program first program instructions to receive a request from an end user computing device for a web page comprising an image file; second program instructions to retrieve the image file from a cache; third program instructions to determine the image file is expired by analyzing an expiration date embedded as metadata in the image file; fourth program instructions to generate a replacement image file; fifth program instructions to serve the web page to the end user computing device with the replacement image file in place of the expired image file; sixth program instructions to delete the expired image file from a web cache; and seventh program instructions to notify an origin of the expired image file of the request for the expired image file. The first, second, third, fourth, fifth, sixth, and seventh program instructions are stored on the computer readable storage media for execution by the CPU via the computer readable memory.

In another aspect of the invention, there is a method of deploying a system for controlling content distribution. The method includes providing a computer infrastructure operable to: determine that content requested by an end user computing device is one of expired and not expired; serve the content to the end user computing device when the determining comprises determining the content is not expired; and block the content from being served to the end user computing device when the determining comprises determining the content is expired. The determining comprises analyzing metadata embedded in the content. The determining is performed at a last serving layer of a network before the end user computing device.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 shows an illustrative environment for implementing the steps in accordance with aspects of the invention;

FIGS. 2 and 3 show systems in accordance with aspects of the invention; and

FIG. 4 shows an exemplary flow in accordance with aspects of the invention.

### DETAILED DESCRIPTION

The present invention generally relates to content distribution, and more particularly, to methods and systems for controlling exposure of expired content. Methods and systems in accordance with aspects of the invention provide a tool for enforcing and/or complying with content expiration dates, and also provide a configurable process of remediation steps for reducing adverse impacts to an end user when desired content is expired and blocked from display. In an embodiment of the invention, metadata attributes that specify a time range and/or expiration date for content are utilized, which time period and/or expiration date aligns with a time period for which the content is licensed for use (e.g., display on the Internet). In accordance with aspects of the invention, the metadata is inspected before the content is served to an end user computing device, which enables the content to be protected from accidental exposure (e.g., on the Internet) after the specified expiration date, while providing set of configurable recovery options to provide an enhanced user experience.

Aspects of the invention are described herein with respect to content comprising images displayed on the Internet. However, the invention is not limited to use with images displayed on the Internet, but, rather, can be used with any desired content and any desired type of network over which content is distributed.

As described in greater detail herein, aspects of the invention may be implemented at a web server and/or Content Delivery Network (CDN) to prevent unwanted distribution of content over the Internet after an expiration date of the content. In embodiments, the metadata, e.g., time range and/or expiration date for the content, may be defined by a content author using existing content management and/or set by an original content owner when the content file is created. In accordance with aspects of the invention, the content metadata is inspected at a web server and/or CDN before being served to the end user computing device. In this manner, implementations of the invention provide the ability to, amongst others:
(i) intercept expired images during the content serving process at the web server or CDN based on metadata in the image and trigger a recovery process per a predefined configuration;
(ii) inspect additional metadata values in the image to identify its origin site and check for an updated image file with an extended expiration date, which may be particularly helpful for CDNs that cache images for long periods of time;
(iii) inspect additional metadata values in the image to identify its origin site and communicate the specifics of the image request and image block, thus allowing the origin site to be notified of the image URL, requesting URL, content details, etc., so the reference can be found and removed;
(iv) automatically generate a replacement image file of equal dimension with a defined solid color, image pattern, or scaled image to serve as a replacement that matches the same size as the original expired image;
(v) delete the cached version of the expired image; and
(vi) write the generated replacement image to serve as a replacement while preserving the origin metadata, which ensures the expired image is no longer available, but the origin can still be checked periodically for an updated image and updated when available.

### System Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

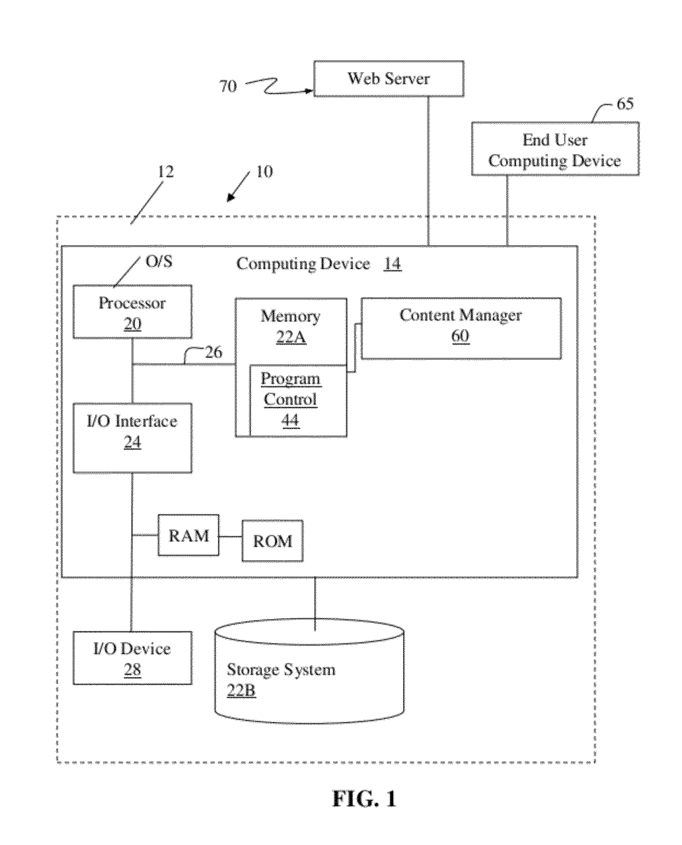

FIG. 1 shows an illustrative environment 10 for managing the processes in accordance with the invention. To this extent, the environment 10 includes a server or other computer infrastructure 12 that can perform the processes described herein. In particular, the computer infrastructure 12 includes a computing device 14. The computing device 14 can be resident on a network infrastructure or computing device of a third party service provider (any of which is generally represented in FIG. 1).

The computing device 14 also includes a processor 20, memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S). The memory (e.g., 22A) may store business intelligence, data mining, regression analysis and/or modeling and simulation tools for execution by the processor 20.

The computing device 14 is in communication with the external I/O device/resource 28 and the storage system 22B. For example, the I/O device 28 can comprise any device that enables an individual to interact with the computing device 14 (e.g., user interface) or any device that enables the computing device 14 to communicate with one or more other computing devices using any type of communications link. The external I/O device/resource 28 may be for example, a handheld device, PDA, handset, keyboard etc.

In general, the processor 20 executes computer program code (e.g., program control 44), which can be stored in the memory 22A and/or storage system 22B. Moreover, in accordance with aspects of the invention, the program control 44 controls a content manager 60 that performs, e.g., the processes described herein. The content manager 60 can be implemented as one or more program code in the program control 44 stored in memory 22A as separate or combined modules. Additionally, the content manager 60 may be implemented as separate dedicated processors or a single or several processors to provide the function of these tools. While executing the computer program code, the processor 20 can read and/or write data to/from memory 22A, storage system 22B, and/or I/O interface 24. The program code executes the processes of the invention. The bus 26 provides a communications link between each of the components in the computing device 14.

In accordance with aspects of the invention, the content manager 60 is configured to perform one or more of the processes described herein including, but not limited to: receiving a request for an image (e.g., content) from an end user computing device; examining metadata contained in the image file specifying a time range and/or expiration date for displaying the image; and determining whether the image is expired (e.g., the time range and/or expiration date has passed). When the content manager 60 determines the image is not expired (e.g., is valid for distribution based on the time range and/or expiration date), the content manager 60 sends the requested image to the end user computing device. On the other hand, when the content manager 60 determines the image is expired (e.g., is no longer valid for distribution based on the time range and/or expiration date), the content manager 60 performs at least one of the following: read metadata of the image to determine an origin of the image; connect to the determined origin and determine whether an updated image file is available with an updated (e.g., valid) time range and/or expiration date that is in the future; notify the origin of that a request for the image was blocked; determine how to generate a replacement image by reading a remediation configuration file; generate a replacement image per the remediation configuration file; copy metadata from the original image to the replacement image; delete the original image from cache and/or any other storage; save the replacement image; and send the replacement image to the requesting end user computing device.

According to aspects of the invention, the content manager 60 resides at a node of a content delivery network (CDN). For example, the computing device 14 may be representative of a CDN node, e.g., a proxy server, with the content manager 60 installed and running as an application (e.g., a plug-in) on the computing device 14. The content manager 60 may be installed and run on each individual node of the CDN, i.e., there may be plural instances of the content manger 60 in a network.

Still referring to FIG. 1, the computing device 14 may reside between and communicate with at least one web server 65 and at least one end user computing device 70. In this manner, the computing device may function as a CDN node, e.g., the computing device 14 may cache frequently accessed content (e.g., images, objects, etc.) and serve such content directly to the end user computing device 70 when the end user computing device 70 makes a request (e.g., a request of an Internet web page). This cached arrangement increases the speed for the end user computing device 70 and reduces the workload on the web server 65. In accordance with aspects of the invention, upon the computing device 14 receiving a request from the end user computing device 60, the content manager 60 examines the requested content prior to serving it to the end user computing device 70 to determine whether the content has expired, e.g., whether the content is no longer valid for distribution to end user computing devices based on a pre-defined time range and/or expiration date associated with the content. In this manner, implementations of the invention provide a mechanism for controlling distribution of time-limited content.

The computing device 14 can comprise any general purpose computing article of manufacture capable of executing computer program code installed thereon (e.g., a personal computer, server, etc.). However, it is understood that the computing device 14 is only representative of various possible equivalent-computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computer infrastructure 12 is only illustrative of various types of computer infrastructures for implementing the invention. For example, in embodiments, the computer infrastructure 12 comprises two or more computing devices (e.g., a server cluster) that communicate over any type of communications link, such as a network, a shared memory, or the like, to perform the process described herein. Further, while performing the processes described herein, one or more computing devices on the computer infrastructure 12 can communicate with one or more other computing devices external to the computer infrastructure 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

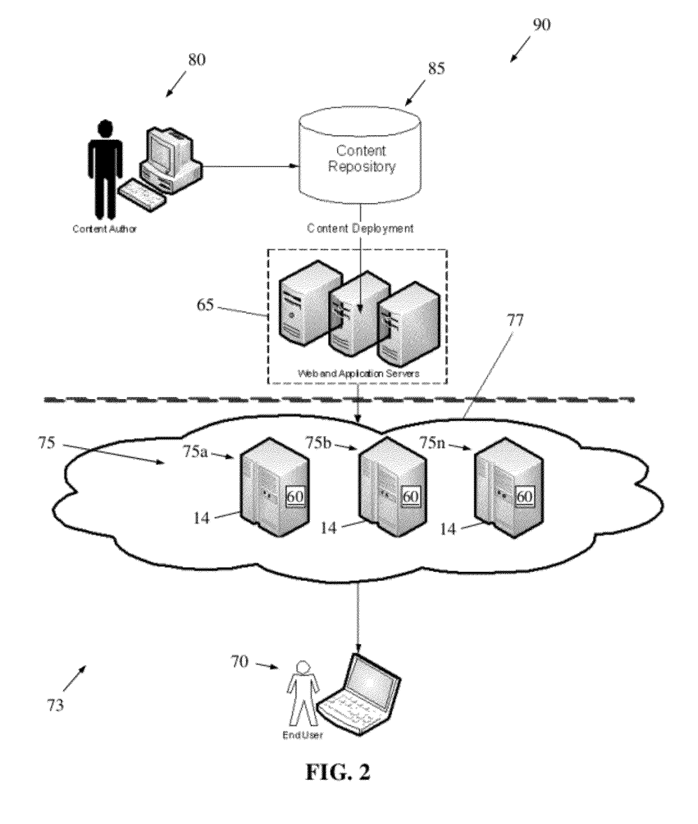

FIG. 2 shows a system 73 in accordance with aspects of the invention. In embodiments, the system 73 comprises a content delivery network (CDN) 75 which may include a plurality of nodes 75a, 75b, . . . , 75n. Each node may comprise a computing device 14 configured with the content manager 60, as described with respect to FIG. 1. The CDN 75 may utilized in the Internet 77 and may sit between and communicate with one or more end user computing devices 70 and one or more web servers 65 (or applications servers).

A content author 80 may create a web page that includes licensed content (e.g., a licensed image) having a known expiration date. Using an enterprise content management system, or other suitable system, the content author 80 tags the webpage and/or the content with an expiration date. The web page including the licensed content may be stored, for example, at a content repository 85 within a host network 90. When the content is approved, the content management system pushes the content to the web server 65, which is also within the host network 90. The web page, including the licensed content, is now available to the end user computing device via the Internet.

When the end user computing device 70 attempts to access the web page, e.g., via URL, a request is transmitted from the end user computing device 70 to the CDN 75. When the CDN 75 has the web page in a cache, the CDN 75 serves the web page to the end user computing device 70 without forwarding the request to the web server 65. On the other hand, when the CDN 75 does not have the web page cached, the CDN 75 requests the web page from the web server 65, receives the web page from the web server 65, forwards a copy of the web page to the end user computing device 70, and stores a copy of the web page in its cache (e.g., web cache).

The enterprise content management system associated with the host network 90 may periodically synchronize the content from the repository 85 to the web server 65 and/or CDN 75. Once the web page and/or licensed content reaches (e.g., passes) the expiration date defined by the content author 80, the web page and/or licensed content is no longer included in the refresh to the CDN 75. In this manner, sometime after the expiration date, the Internet cache of the CDN 75 will expire and the CDN 75 will not be able to refresh from the original source, i.e., the web server 65. However, this leaves open the possibility that the CDN 75 may have a copy of the licensed content in its cache after the content expiration date but before the cache needs refreshed. This situation could result in the licensed content being served to the end user computing device 70 (from the CDN cache) even after the expiration date of the licensed content.

Accordingly, in implementations of the invention, metadata defining the expiration date of the licensed content is embedded into the licensed content, and the content manager 60 examines this metadata prior to serving the licensed content to the end user computing device 70. In this manner, even cached data is examined prior to be served to the end user computing device, which reduces or altogether eliminates the chance that licensed content is served to an end user computing device after its expiration date. The functions of the content manager 60 described herein may be performed in addition to the above-described functions of the enterprise content management system to provide additional control over the distribution of licensed content.

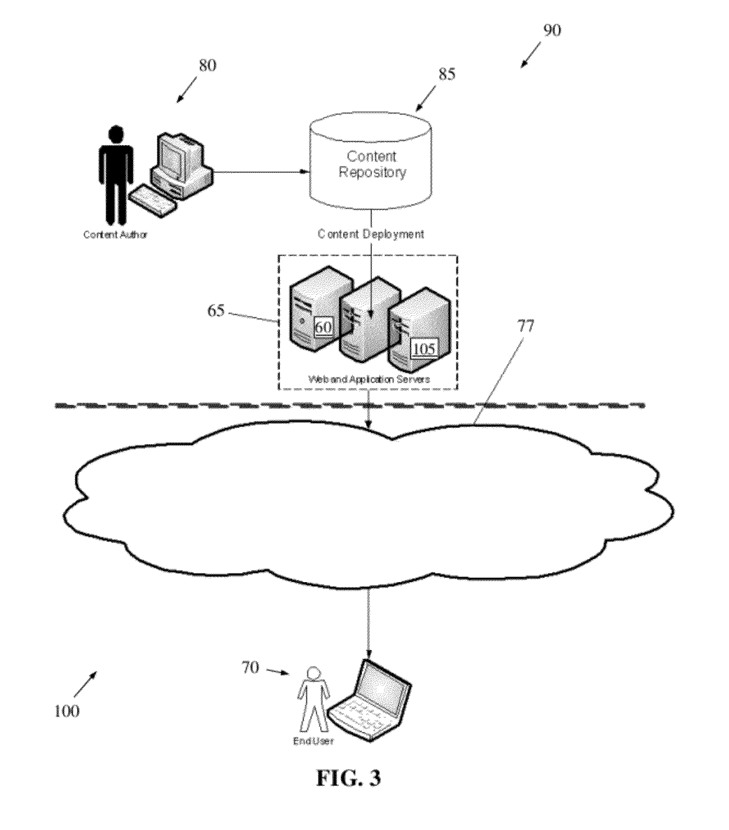

FIG. 3 shows another system 100 in accordance with aspects of the invention. In embodiments, the system 100 may be implemented without a content delivery system CDN. For example, the system 100 may comprise one or more host web servers 65 (or application servers) connected to the Internet 77, and one or more end user computing devices 70 also connected to the Internet 77. In this manner, the web server 65 handles a request from the end user computing device 70 for a web page. The web server 65 may comprise the content manager 60, such that examination of metadata embedded in requested content is performed at the web server 65 rather than at a CDN node. The web server 65 may also comprise a cache 105 (e.g., web cache) that functions similar to a cache at a CDN node, e.g., to temporarily store copies of content in order to speed up the handling of content requests.

In both exemplary systems 73 and 100, the content manager 60 resides and functions at the last serving layer (or last serving node) before the end user computing device 70. For example, as depicted in FIGS. 2 and 3, the network does not include any additional serving layers and/or serving nodes (e.g., web servers, proxy servers, CDN nodes, etc.) between the content manager 60 and the end user computing device 70, such that the content manager 60 is said to be running at the last serving layer before the end user computing device 70. Moreover, as used herein, the last serving layer before the end user computing device connotes that the end user computing device does not function as a serving layer serving nodes (e.g., web server, proxy server, CDN node, etc.) to pass the content along to other devices. In this manner, the content is not served to the end user computing device 70 in any form after the expiration date.

In accordance with aspects of the invention, enforcement of expired content during distribution by the content manager 60 running at the last serving layer represents an improvement over methods where the enforcement of expired content is performed upstream of the last serving layer, e.g., at the content repository 85. For example, control techniques that analyze an expiration date during a web cache refresh may disadvantageously leave a copy of expired content in the web cache during the time period after the expiration date and before the next cache refresh, which could result in the expired content being served to an end user computing device during this time period.

In accordance with aspects of the invention, enforcement of expired content during distribution by the content manager 60 running at the last serving layer also represents an improvement over methods where the enforcement of expired content is performed downstream of the last serving layer, e.g., at an endpoint such as the end user computing device 70. In endpoint enforcement schemes, the content is served to the end user computing device 70 regardless of any expiration date, and an end client (e.g., a program running on the end user computing device 70) determines whether to permit display of the content on the end user computing device 70. Such endpoint enforcement systems may be circumvented by various techniques, such as altering the end user computing device 70 system date and time to a point in the past, e.g., prior to the expiration date of the content, permitting the end user computing device to view the expired content. Also, by embedding the metadata in the content, implementations of the invention provide an improved protection and reliability over systems that retrieve expiration data separately from the content.

In embodiments, the metadata embedded in the licensed content defines time range and/or expiration date for the content. The metadata may be embedded in the content in any desired manner, such as, for example, using data definitions specified in the International Press Telecommunications Council (IPTC) Information Interchange Model (IIM). For example, the IIM includes an attribute named “Iptc.Application2.ExpirationDate” that designates the latest date the provider or owner intends the object data to be used. The invention is not limited to this particular type of metadata, however, and any suitable method may be used to tag the licensed content with metadata that defines an expiration date of the content.

### Flow Diagram

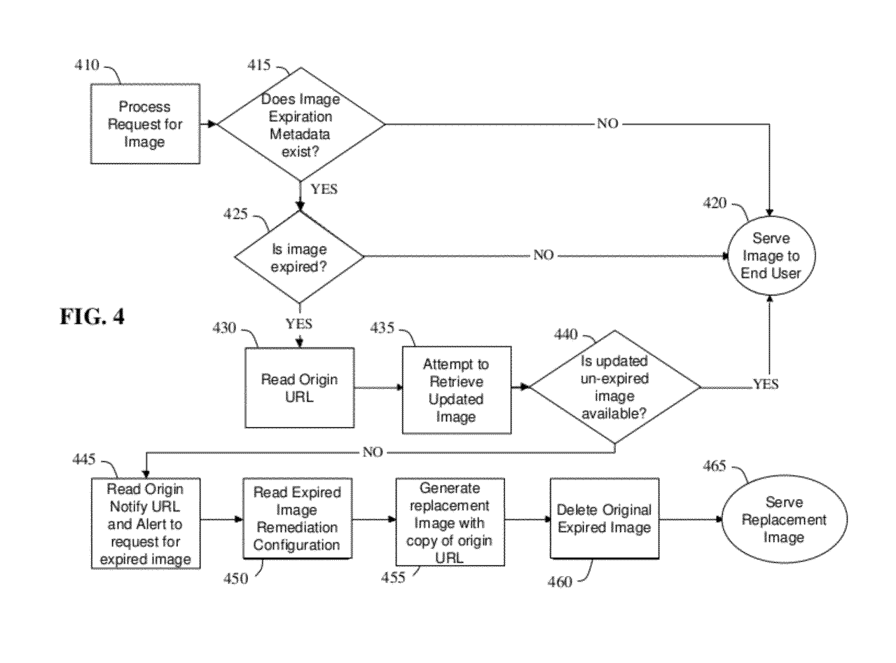

FIG. 4 shows an exemplary flow for performing aspects of the present invention. The steps of FIG. 4 may be implemented in the environment of FIGS. 1-3, for example.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Furthermore, the invention can take the form of a computer program product accessible from a computer-usable or computer-readable medium providing program code for use by or in connection with a computer or any instruction execution system. The software and/or computer program product can be implemented in the environments of FIGS. 1-3. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-R/W) and DVD.

FIG. 4 depicts an exemplary flow for a process of controlling content distribution in accordance with aspects of the invention. The steps of FIG. 4 are described with respect to content comprising an image, e.g., an image file. However, the invention is not limited to content comprising an image, and aspects of the invention may be used with any desired content including, but not limited to, images, web objects, other downloadable objects (e.g., media files, software, documents), applications, realtime media streams, etc.

At step 410, a request for an image (e.g., content) is received. The request for the image may be generated by an end user computing device (e.g., end user computing device 70) who is requesting an Internet web page (e.g., via URL) that contains the image. The request for the image at step 410 may be received by a content manager (e.g., content manager 60).

At step 415, the content manager determines whether an image file of the requested image contains metadata that defines an expiration date for the image. In embodiments, the content manager retrieves a copy the image file (e.g., stored in cache) and examines the image file for any embedded metadata. When the requested image file does not include metadata that defines an expiration date, then at step 420 the content manger serves the requested image to the requesting end user computing device. For example, the content manger transmits the image as data over a network to the end user computing device.

On the other hand, when at step 415 it is determined that the requested image file includes metadata that defines an expiration date, then at step 425 the content manger determines whether the image is expired. In embodiments, the content manager makes this determination by comparing an expiration date and/or time range defined in the metadata to the current date, e.g., determined from a system clock. Any desired level of granularity may be used in defining the expiration date and/or time range and also in making the determination in step 425, e.g., years, months, weeks, days, hours, minutes, second, etc. When, at step 425, it is determined that the image is not expired, then the process proceeds to step 420 where the image is served to the end user computing device.

At step 430, in cases where it is determined the image has expired, the content manager determines an origin of the image. In embodiments, additional metadata embedded in the image file, or otherwise associated with the image, defines an origin of the image. The origin may be defined in any suitable manner, such as by a URL associated with an origin web server (e.g., web server 65). The content manager determines the origin by examining this additional metadata.

At step 435, the content manager requests an updated image from the origin determined at step 430. In embodiments, the content manager transmits a message to the origin including: an identity of the expired image, e.g., the image that was requested by the end user computing device, and a request for an updated version of the requested image, e.g., a new image file having an expiration date in the future.

At step 440, the content manager determines whether an updated version of the image is available based on two possible outcomes in response to the request at step 435, i.e., the origin web server either returns an updated image to the content manager or does not return an updated image. When the origin web server returns an updated image, the determination at step 440 is positive, and the content manager saves a copy of the updated image and serves the updated image to the end user computing device at step 420. On the other hand, when the origin web server does not return an updated image, the determination at step 440 is negative, meaning the end user computing device's request cannot be completely fulfilled because the requested image has expired and an updated image is not available.

When the determination at step 440 is negative, the process proceeds to step 445 where the content manager notifies the origin that a request for the expired image was made and blocked. In embodiments, the metadata embedded in the requested image file may include an “origin notify URL,” and at step 445 the content manager determines this origin notify URL by examining the metadata. Also, at step 445, the content manager transmits to the origin notify URL a message indicating the requested image that was blocked. The message may also include specifics of the end user computing device request, such as the image URL, the requesting URL, image details, etc., so that the origin can make updates such as finding and removing references to the image.

At step 450, the content manager reads a remediation configuration file associated with the expired image. In accordance with aspects of the invention, the remediation configuration file provides instructions for generating a replacement image. For example, when the requested (and expired) image is part of a web page, the remediation configuration file may include instructions for generating a replacement image having any desired aesthetic design (e.g., solid color, repeated pattern, scaled version of a single image, etc.) and the same dimensions (e.g., length, width, etc.) as the requested image. The remediation configuration file may be stored at any suitable network location, such as a CDN node or web server where the content manger is running. For example, the remediation configuration file may be stored in the httpd.conf file or other configuration file.

At step 455, the content manager generates a replacement image in accordance with the instructions provided by the remediation configuration file. The generating the replacement image may additionally include copying some or all of the metadata from the requested (and expired) image file to the new replacement image file. For example, the origin URL may be embedded as metadata in the replacement image file. Step 455 may also include the content manger saving a copy of the generated replacement image file, e.g., in the web cache.

At step 460, the content manger deletes the requested (and expired) image. In embodiments, the content manager is running at a CDN node, and step 460 comprises deleting all copies of the requested image file that are stored (e.g., cached) at the CDN node. In other embodiments, the content manager is running at a host web server or application server, and the step 460 comprises deleting all copies of the requested image file that are stored in a cache (e.g., cache 105) associated with the web or application server. By deleting cached copies of the expired image, implementations of the invention further protect against any possible distribution and/or viewing of the image beyond the expiration date.

At step 465, the replacement image is served to the end user computing device. In embodiments, the content manager transmits the replacement image to the end user computing device as data over the network. The replacement image may be transmitted alone or as part of other content. For example, the replacement image may be served as a replacement image included in a web page. The layout of the webpage may be preserved by generating the replacement image with the same dimensions as the original (expired) image, e.g., at step 455, which provides a better experience for the end user when the requested image is expired and blocked.

The process of FIG. 4 may be implemented in the system 73 of FIG. 2 in which the content manager is located and running at a CDN node. The process of FIG. 4 may also be implemented in the system 100 of FIG. 3 in which the content manager is located and running at a web server or application server of a host. In both environments, e.g., systems 73 and 100, the functions of FIG. 4 may be performed in addition to other content management systems. For example, in addition to performing the functions described in FIG. 4, a system in accordance with aspects of the invention may also be configured to cause the content delivery system to stop deploying the content to application or web servers after an expiration date. This is a separate and additional measure of controlling content distribution that may be effectuated by enforcing the expiration date during periodic refresh a web cache. In particular, the system may be configured such that content in a web cache (either at a CDN node or at a host web server) is periodically refreshed, e.g., the content is deleted from the cache and re-acquired from the origin content repository. During such a periodic refresh, the expiration date of any content may be analyzed at the origin such that expired content is not delivered to the cache. In this manner, implementations of the invention may utilize plural techniques for controlling the distribution of content over a network.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principals of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

What is claimed is:

1. A method implemented in a computer infrastructure, comprising:
receiving a request for content from an end user computing device;
analyzing metadata embedded in the content to determine whether the content has expired;
serving the content to the end user computing device when content is not expired; and
blocking the content from being served to the end user computing device when the content is expired.

2. The method of claim 1, wherein the metadata embedded in the content comprises an expiration date of the content.

3. The method of claim 2, wherein the analyzing the metadata comprises comparing the expiration date to a current date.

4. The method of claim 1, wherein the determining is performed at a last serving layer before the end user computing device.

5. The method of claim 4, wherein the determining is performed by a content manager running at one of Content Delivery Network (CDN) node and a host web server.

6. The method of claim 1, wherein the analyzing comprises determining the content is expired, and further comprising:
determining an origin of the content from the metadata; and
requesting updated content from the origin.

7. The method of claim 6, further comprising:
receiving the updated content from the origin; and
serving the updated content to the end user computing device.

8. The method of claim 6, further comprising:
determining the updated content is not available from the origin;
generating replacement content; and
serving the replacement content to the end user in place of the content.

9. The method of claim 8, wherein the generating the replacement content comprises:
reading a remediation configuration file; and
generating the replacement content according to instructions provided by the remediation configuration file.

10. The method of claim 9, wherein:
the content comprises an image;
the replacement content comprises another image having dimensions equal to dimensions of the image; and
the another image has a different design than the image.

11. The method of claim 8, wherein the generating the replacement content further comprises embedding at least some of the metadata in the replacement content.

12. The method of claim 6, further comprising deleting the content from a cache after the determining the content is expired.

13. The method of claim 6, further comprising alerting the origin of the request for content after the determining the content is expired.

14. The method of claim 1, wherein a service provider at least one of creates, maintains, deploys and supports the computer infrastructure.

15. The method of claim 1, wherein steps of claim 1 are provided by the service provider on a subscription, advertising, and/or fee basis.

16. A system implemented in hardware, comprising:
a processor executing a content manager that operates to:
retrieve, from cache, content requested by an end user computing device;
determine the content is one of expired and not expired, wherein the determining comprises analyzing metadata embedded in the content;
serve the content to the end user computing device when the determining comprises determining the content is not expired; and
block the content from being served to the end user computing device when the determining comprises determining the content is expired.

17. The system of claim 16, wherein:
the content comprises an image;
the metadata comprises an expiration date embedded in an image file defining the image; and
the analyzing comprises comparing the expiration date to a current date.

18. The system of claim 17, wherein the content manager is running at one of Content Delivery Network (CDN) node and a host web server at a last serving layer before the end user computing device.

19. The system of claim 18, wherein the determining comprises determining the content is expired, and further comprising:
determining an origin of the image from the metadata;
requesting from the origin an updated image having a later expiration date;
serving the updated image to the end user when the updated image is received from the origin; and
generating and serving a replacement image to the end user when the updated image is not received from the origin, wherein the generating and serving the replacement image comprises generating the replacement image based on a remediation configuration file.

20. A computer program product comprising a computer usable storage medium having readable program code embodied in the storage medium, the computer program product includes at least one component operable to:
receive a request for an image file from an end user computing device;
retrieve the image file from a cache;
determine the image file is expired by comparing an expiration date embedded as metadata in the image file to a current date; and
serve to the end user computing device one of: an updated image file having a later expiration date, and a replacement image file generated according to a remediation configuration file.

21. The computer program product of claim 20, wherein the at least one component is operable to:
delete the image file from a web cache; and
notify an origin of the image file of the request for the image file.

22. A computer system for controlling content distribution, the system comprising:
a CPU, a computer readable memory, and a computer readable storage media;
first program instructions to receive a request from an end user computing device for a web page comprising an image file;
second program instructions to retrieve the image file from a cache;
third program instructions to determine the image file is expired by analyzing an expiration date embedded as metadata in the image file;
fourth program instructions to generate a replacement image file;
fifth program instructions to serve the web page to the end user computing device with the replacement image file in place of the expired image file;
sixth program instructions to delete the expired image file from a web cache; and
seventh program instructions to notify an origin of the expired image file of the request for the expired image file,
wherein the first, second, third, fourth, fifth, sixth, and seventh program instructions are stored on the computer readable storage media for execution by the CPU via the computer readable memory.

23. A method of deploying a system for controlling content distribution, comprising:
providing a computer infrastructure operable to:
determine that content requested by an end user computing device is one of expired and not expired;
serve the content to the end user computing device when the determining comprises determining the content is not expired; and
block the content from being served to the end user computing device when the determining comprises determining the content is expired,
wherein the determining comprises analyzing metadata embedded in the content, and
the determining is performed at a last serving layer of a network before the end user computing device.

24. The method of claim 23, wherein:
the content comprises an image file contained in a web page;
the metadata comprises an expiration date embedded in the image file; and
the analyzing comprises comparing the expiration date to a current date.

25. The method of claim 24, wherein the determining comprises determining the content is expired, and further comprising:
determining an origin of the content from the metadata;
requesting from the origin an updated image file having a later expiration date;
serving the web page with the updated image file to the end user computing device when the updated image file is received from the origin; and
generating a replacement image file and serving the web page with the replacement image file to the end user when the updated image file is not received from the origin, wherein the generating the replacement image file comprises generating the replacement image file based on a remediation configuration file.
